(19) United States
(12) Patent Application Publication
(10) Pub. No.: US 2026/0126571 A1
(43) Pub. Date: May 7, 2026

(54) METHOD AND APPARATUS FOR EXPANDING FOV OF GESTURE RECOGNITION DEVICE

(71) Applicant: ELECTRONICS AND TELECOMMUNICATIONS RESEARCH INSTITUTE, Daejeon (KR)

(72) Inventor: Min Sung YOON, Daejeon (KR)

(21) Appl. No.: 19/371,815

(22) Filed: Oct. 28, 2025

(30) Foreign Application Priority Data
Nov. 6, 2024 (KR) 10-2024-0156008

(51) Int. Cl. G02B 5/18; B82Y 20/00; G02B 1/00; G06F 3/01

(52) U.S. Cl. CPC G02B 5/1809; B82Y 20/00; G02B 1/002; G06F 3/017

(57) ABSTRACT

A method and an apparatus for expanding a field of view of a gesture recognition device. An aspect of the present disclosure provides a meta-grating structure layer including: a substrate; and a plurality of nanostructures provided on the substrate, wherein the nanostructures of different sizes are periodically arranged on the substrate.

### CROSS-REFERENCE TO RELATED APPLICATION

The present application claims priority to Korean Patent Application No. 10-2024-0156008, filed on Nov. 6, 2024 in the Korea Intellectual Property Office, the entire contents of which are incorporated herein by reference.

### TECHNICAL FIELD

The present disclosure relates to a method and an apparatus for expanding a field of view of a gesture recognition device. More specifically, the present disclosure relates to a method and an apparatus for expanding a range of a space recognizable by a gesture recognition device by using a meta-grating structure.

### BACKGROUND

The statements in this section merely provide background information related to the present disclosure and do not necessarily constitute prior art.

In recent years, with the development of eXtended Reality (XR) display or holographic display technology, there is an increasing need for a gesture recognition device capable of interacting with immersive or 3D image content without a direct touch.

In one example, a Leap Motion Controller (LMC) is a user interface device that is capable of finely recognizing a user's hand gesture. A recognition sensor of the LMC includes an RGB camera that distinguishes colors and an IR camera that distinguishes depths. The recognition sensor of the LMC may track the movement of both hands and each finger of the user, thereby controlling an image or interacting with content remotely from a computer vision platform.

The size of a three-dimensional spatial region in which the LMC is capable of recognizing a hand gesture is defined by a recognition depth and a field of view (FOV). For example, referring to FIG. 9, in the case of an LMC (model name: leap motion controller 2) manufactured by Ultraleap, it is known that the recognition depth r is 10 cm≤r≤60 cm, and the field of view θFOV is 160°. Therefore, when a user's hand is located within the FOV range (θ≤θFOV), the LMC may recognize the user's hand, but when the user's hand is located outside the FOV range (θ>θFOV), the LMC may not recognize the user's hand.

Limitations in the space recognizable by gesture recognition devices are problematic for hand gesture-based rehabilitation and rehabilitative training, XR instrument-based contactless interaction, robot/vehicle remote control, and the like. Therefore, there is a need for a technology capable of expanding a gesture recognition range of a gesture recognition device.

### SUMMARY

An object of the present disclosure is to provide a method and an apparatus capable of enlarging or expanding a field of view (FOV) of a gesture recognition device.

More specifically, the object of the present disclosure is to provide a system in which a user may interact more freely and contactlessly by enlarging or expanding an FOV of a gesture recognition device.

The technical objects of the present disclosure are not limited to those described above, and other technical objects not mentioned above may be understood clearly by those skilled in the art from the descriptions given below.

An embodiment of the present disclosure provides a meta-grating structure layer including: a substrate; and a plurality of nanostructures provided on the substrate, wherein the nanostructures of different sizes are periodically arranged on the substrate.

Another embodiment of the present disclosure provides a system for expanding a field of view of a gesture recognition device, the system including: one or more meta-grating structure layers according to the embodiment above, and a gesture recognition device comprising one or more recognition sensors capable of recognizing a gesture of a user, each of the meta-grating structure layers is disposed on top of each of the recognition sensors to receive light output from each of the recognition sensors.

According to an embodiment of the present disclosure, by using an optical device including a meta-grating structure layer, there is an effect that a field of view (FOV) of a gesture recognition device may be enlarged.

According to an embodiment of the present disclosure, there is an effect that a region of a space recognizable by the gesture recognition device may be expanded by enlarging the FOV of the gesture recognition device.

According to an embodiment of the present disclosure, a user's convenience, stability, immersion, and the like may be improved by expanding the region of a space recognizable by the gesture recognition device.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 shows an exemplary diagram illustrating both a plan view and a side view of a meta-grating structure layer according to an embodiment of the present disclosure.

FIG. 2 shows an exemplary diagram illustrating both a plan view and a side view of a unit cell constituting a meta-grating structure layer according to an embodiment of the present disclosure.

FIG. 3 shows an exemplary diagram for describing an experimental scheme for determining spacing, width, height, and the like of nanostructures arranged on a meta-grating structure layer.

FIG. 4 shows a graph showing the relationship between the width and a phase shift of a nanostructure.

FIG. 5 shows a graph showing the relationship between the height and a light efficiency of a nanostructure.

FIG. 6 shows a table showing a diffraction angle (θ1) and a light efficiency (η) of a first-order diffracted light according to an incident angle of a plane wave incident on a meta-grating structure layer according to an embodiment of the present disclosure.

FIG. 7 shows a table showing a diffraction angle and a light efficiency of a first-order diffracted light according to an incident angle of a light incident on a meta-grating structure layer according to another embodiment of the present disclosure.

FIG. 8 shows an exemplary diagram illustrating an example of a spatial expansion system including an optical device according to an embodiment of the present disclosure.

FIG. 9 shows an exemplary diagram showing a field of view of a conventional gesture recognition device.

FIG. 10 shows an exemplary diagram showing a field of view of a gesture recognition device to which an optical device is coupled.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

An optical device according to the present disclosure may expand a field of view (FOV) of a gesture recognition device. More specifically, the optical device according to the present disclosure may be located above a recognition sensor of a gesture recognition device to receive light output from the recognition sensor, and output light diffracted by a meta-grating structure layer, thereby expanding an FOV of the gesture recognition device.

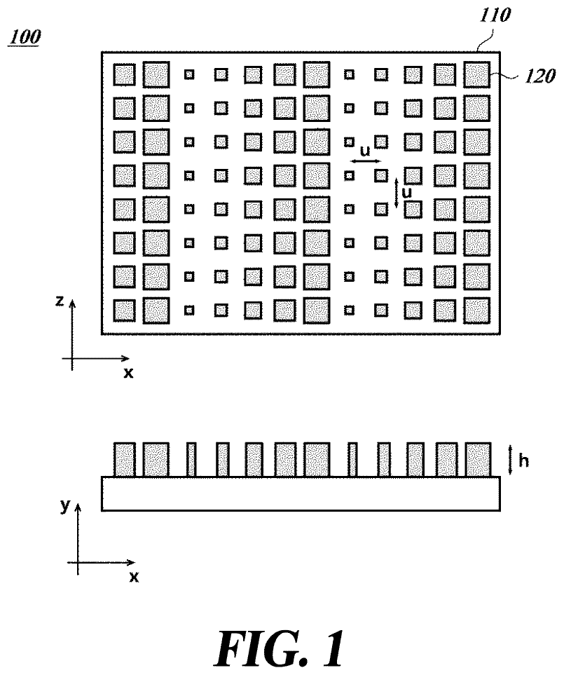

FIG. 1 shows an exemplary diagram illustrating both a plan view and a side view of a meta-grating structure layer according to an embodiment of the present disclosure.

The meta-grating structure layer 100 includes a substrate 110 and a plurality of nanostructures 120 provided on the substrate 110.

The substrate 110 may be a transparent substrate that transmits light. For example, the substrate 110 may be a fused silica substrate, a silicon substrate, or a glass substrate, but is not limited thereto.

The plurality of nanostructures 120 are provided on the substrate 110. The material of the nanostructure may consist of or include TiO2, but is not limited thereto.

Each of the nanostructures 120 may have a nano-sized structure (form). In an embodiment, each of the nanostructures 120 may be a columnar structure. In one example, each of the nanostructures 120 may be a square pillar, but is not limited thereto.

The plurality of nanostructures 120 may have different structures. In other words, the plurality of nanostructures 120 may be configured to differ from one another in one or more of the shape of the nanostructure, the width of the nanostructure and the height (h) of the nanostructure. Referring to FIG. 1, in one embodiment, the shape and height (h) of the nanostructures 120 are the same, but the width of the nanostructures 120 is different.

The nanostructures 120 of different sizes are periodically arranged on the substrate 110. Referring to FIG. 1, the plurality of nanostructures 120 are sequentially arranged in the x-axis and z-axis directions. In particular, the plurality of nanostructures 120 of different sizes are periodically arranged in the x-axis direction. Here, the arrangement of repeating nanostructures 120 may hereinafter be referred to as a unit cell. The unit cell is a basic unit constituting a meta-grating structure. In one embodiment, a unit cell of the meta-grating structure layer 100 includes a sequence of five nanostructures 120 that sequentially increase in width.

The plurality of nanostructures 120 may be arranged at equal intervals (u), but are not limited thereto. Here, the arrangement interval means the length of a straight line that connects the center points of two adjacent nanostructures.

Meanwhile, although FIG. 1 illustrates an example in which the plurality of nanostructures 120 are provided on top of the substrate 110, it is also possible to provide the nanostructures 120 on a lower surface of the substrate 110.

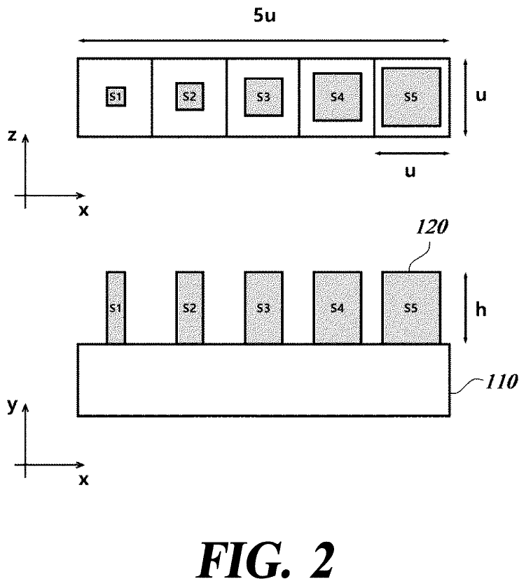

FIG. 2 shows an exemplary diagram illustrating both a plan view and a side view of a unit cell constituting a meta-grating structure layer according to an embodiment of the present disclosure.

The unit cell of the meta-grating structure layer 100 includes a substrate 110 and a plurality of nanostructures S1-S5 provided on the substrate 110.

The plurality of nanostructures S1-S5 are sequentially arranged in the x-axis direction, and each of the nanostructures S1-S5 is located on a basis of size u×u. Each of the nanostructures S1-S5 is located at the center of the basis, so that the spacing between each of the nanostructure S1-S5 coincides with the width (u) of the basis.

Each of the sequentially arranged nanostructures S1-S5 is in the shape of a square pillar having a height of h. In addition, referring to the plan view of FIG. 2, the width of the plurality of nanostructures S1-S5 increases sequentially. In other words, the lengths of the plurality of nanostructures S1-S5 in the y-axis direction are constant as h, and the lengths in the x-axis direction and the length in the z-axis direction sequentially increase.

The horizontal length and the vertical length of the unit cell are determined by the number of nanostructures included in the unit cell and the width u of the basis. In one embodiment, the unit cell includes a sequence of five nanostructures S1-S5 and the width of the basis is u, such that the horizontal length of the unit cell is 5u and the vertical length of the unit cells is u.

The meta-grating structure for expanding the FOV of a gesture recognition device is determined by adjusting various parameters such as the material of the substrate and the shape, width, height, and material of the nanostructures. In order to determine various parameters and verify the performance of the meta-grating structure layer, an optical simulation-based approach may be used.

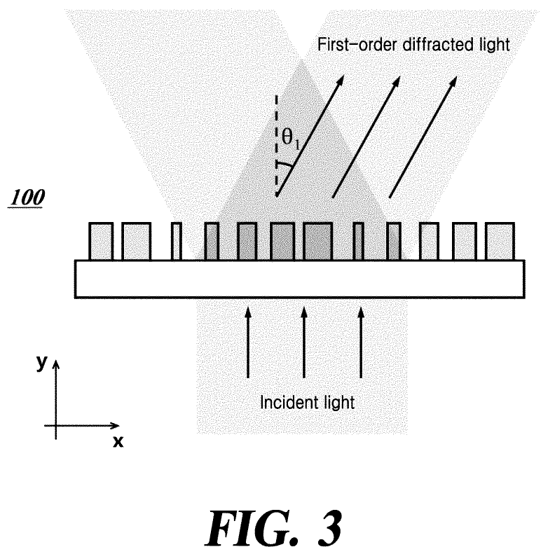

FIG. 3 shows an exemplary diagram for describing an experimental scheme for determining spacing, width, height, and the like of nanostructures arranged in a meta-grating structure layer.

Light incident on the meta-grating structure layer 100 is diffracted while passing through the meta-grating structure layer 100. Experiments are performed by measuring the phase shift, diffraction angle (θ1), intensity, and the like of first-order diffracted light.

The width of the nanostructures 120, that is, the length of the square pillar in the x-axis direction and the z-axis direction, may be determined based on a phase-fill factor relationship curve representing the phase shift of the first-order diffracted light according to a fill factor. Here, the fill factor means a ratio of the width of the nanostructure and the width of the basis.

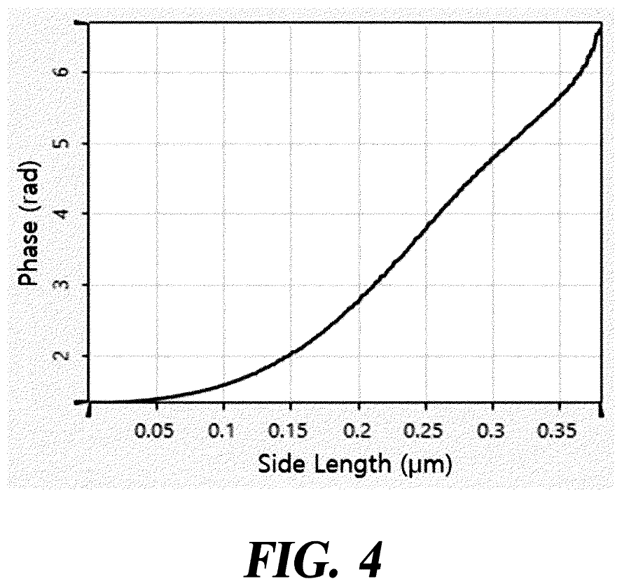

FIG. 4 shows a graph showing the relationship between the width and a phase shift of a nanostructure. Here, the width of the basis has a constant value of 380 nm, and the width of the nanostructure has a value of less than 380 nm. Referring to FIG. 4, it may be seen from the relationship curve between the width and the phase shift of the nanostructure that the nanostructure of the meta-grating structure layer 100 may generate a phase modulation of 2π.

The height (h) of the nanostructures 120, that is, the length of the square pillar in the y-axis direction, may be determined based on the light efficiency. Here, the light efficiency (or diffraction efficiency) means a value obtained by dividing the intensity of light incident on the meta-grating structure layer 100 by the intensity of the first-order diffracted light diffracted by the meta-grating structure layer 100. Mathematical Formula 1 is a formula representing the optical efficiency (η).

$$η = - \frac{T}{I} \qquad Mathematical Formula 1$$

In Mathematical Formula 1, I is the intensity of light incident on the meta-grating structure layer 100, and T is the intensity of the first-order diffracted light diffracted by the meta-grating structure layer 100.

The light efficiency (η) varies with the height of the nanostructures 120. Accordingly, in the graph representing the relationship between the height of the nanostructures and the light efficiency (θ), the height of the nanostructure at which the light efficiency (η) is maximized may be determined as the height (h) of the nanostructures 120 of the meta-grating structure layer 100.

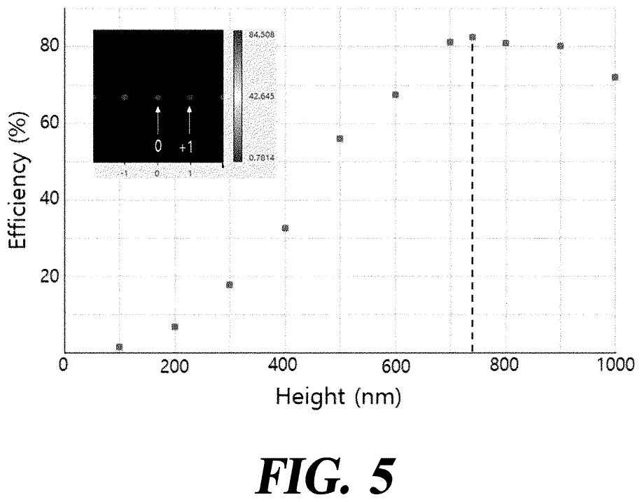

FIG. 5 shows a graph showing the relationship between the height and a light efficiency of a nanostructure. The figure inserted at the top left in the graph of FIG. 5 shows a spot of various nth-order diffracted lights (n is an integer) formed on a monitoring screen. Referring to the figure on the upper left, it may be seen that the intensity of the first-order diffracted light is the highest.

The width of the basis of the meta-grating structure layer 100 has a constant value of 380 nm, and the width of the nanostructure has a value of less than 380 nm. Referring to FIG. 5, it may be seen that when the height of the nanostructure is 740 nm, the light efficiency is maximized. Accordingly, the height (h) of the nanostructures of the meta-grating structure layer 100 according to an embodiment may be determined to be 740 nm.

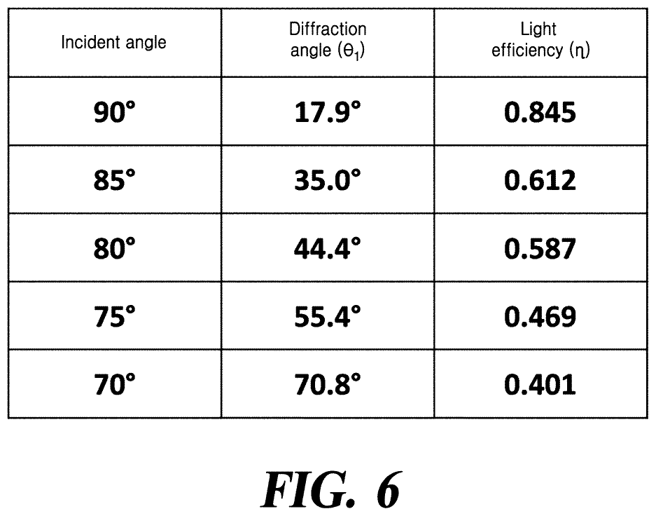

FIG. 6 shows a table showing a diffraction angle (θ1) and a light efficiency (η) of a first-order diffracted light according to an incident angle of a plane wave incident on a meta-grating structure layer according to an embodiment of the present disclosure.

The meta-grating structure layer 100 according to an embodiment of the present disclosure is composed of a substrate including fused silica and nanostructures in the form of square pillars including TiO2. The refractive index of the nanostructures is 2.33, and the refractive index of the substrate is 1.457. Five nanostructures having different widths are periodically arranged on the substrate, the width of each nanostructure is 100 nm, 150 nm, 200 nm, 250 nm, and 300 nm, and the height is 740 nm. The width of a square-shaped basis is 380 nm. Therefore, the unit cell has a horizontal length of 5×380 nm and a vertical length of 380 nm.

Referring to FIG. 6, the diffraction angle (θ1) of the first-order diffracted light is 17.9°, and the light efficiency (η) is 0.845 when a plane wave is incident on the meta-grating structure layer 100 in a perpendicular direction (positive y-axis direction). In addition, the diffraction angle (θ1) and the light efficiency (η) of the first-order diffracted light according to the incident angles (85°, 80°, 75°, and 70°) of the plane waves incident on the meta-grating structure layer 100 are shown in the table of FIG. 6.

From the results of FIG. 6, it may be seen that the diffraction angle of the first-order diffracted light increases as the incident angle increases. In addition, it may be seen that the light efficiency of the first-order diffracted light decreases as the incident angle increases.

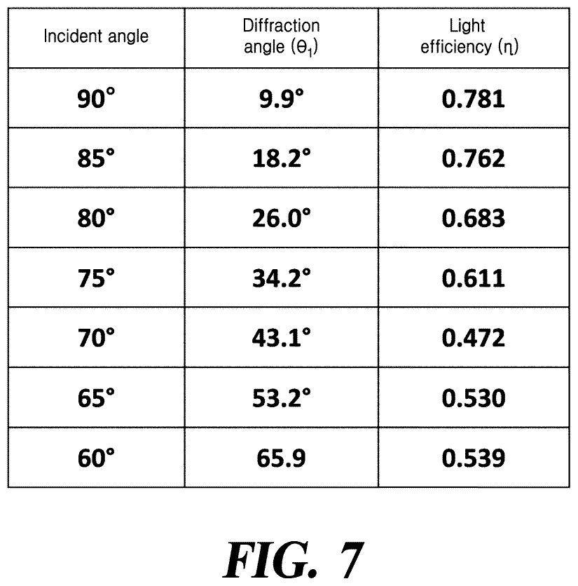

FIG. 7 shows a table showing a diffraction angle and a light efficiency of a first-order diffracted light according to an incident angle of a light incident on a meta-grating structure layer according to another embodiment of the present disclosure.

The meta-grating structure layer according to another embodiment of the present disclosure is composed of a substrate including fused silica and nanostructures in the form of square pillars including TiO2. The refractive index of the nanostructures is 2.33, and the refractive index of the substrate is 1.457. Twelve nanostructures having different widths are periodically arranged on the substrate, the width of each of the nanostructures is 30 nm, 60 nm, 90 nm, 120 nm, 150 nm, 180 nm, 210 nm, 240 nm, 270 nm, 300 nm, 330 nm, and 360 nm, and the height is 650 nm. The width of a square-basis is 380 nm. Therefore, the unit cell has a horizontal length of 10×380 nm and a vertical length of 380 nm.

Referring to FIG. 7, the diffraction angle (θ1) of the first-order diffracted light is 9.85°, and the light efficiency η is 0.781 when a plane wave is incident on the meta-grating structure layer in a perpendicular direction (positive y-axis direction). In addition, the diffraction angle θ1 and the light efficiency η of the first-order diffracted light according to the incident angles (85°, 80°, 75°, 70°, 65°, and 60°) of the light incident on the meta-grating structure layer are shown in the table of FIG. 7.

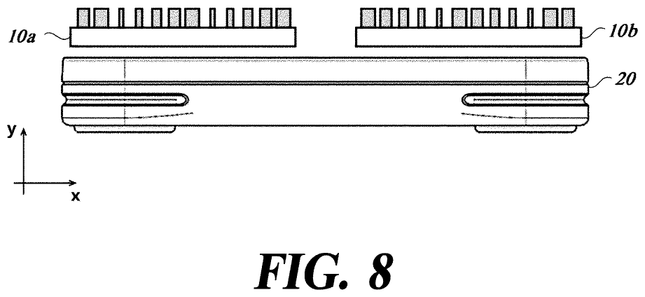

FIG. 8 shows an exemplary diagram illustrating an example of a spatial expansion system including an optical device according to an embodiment of the present disclosure.

Referring to FIG. 8, the spatial expansion system includes a first optical device 10a, a second optical device 10b, and a gesture recognition device 20. Here, the first optical device 10a and the second optical device 10b include a meta-grating structure layer 100. The first optical device 10a may be disposed above a left recognition sensor of the gesture recognition device 20, and the second optical device 10b may be disposed above a right recognition sensor of the gesture recognition device 20.

The first optical device 10a and the second optical device 10b may each receive light output from a recognition sensor of the gesture recognition device 20 and output light diffracted by the meta-grating structure layer 100, thereby expanding the FOV of the gesture recognition device 20. Thus, the range of space that the gesture recognition device 20 may recognize is expanded. Mathematical Formula 2 is a formula for calculating the FOV (ΦFOV) extended by the meta-grating structure layer 100.

$${Φ}_{FOV} = {θ}_{FOV} + 2 {θ}_{1} \qquad Mathematical Formula 2$$

In Mathematical Formula 2, θFOV is an original FOV of the gesture recognition device 20, and θ1 is a first-order diffraction angle of light diffracted by the meta-grating structure layer 100.

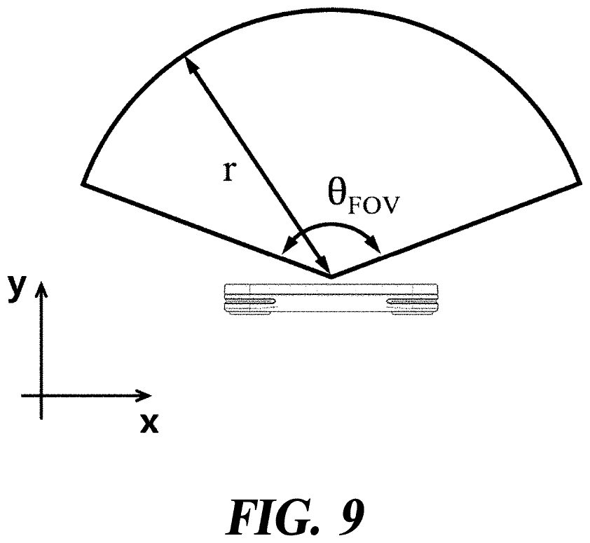

FIG. 9 shows an exemplary diagram showing an FOV of a conventional gesture recognition device.

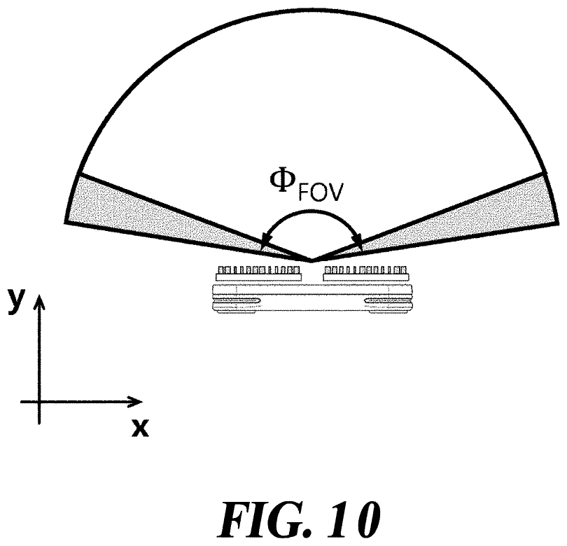

FIG. 10 shows an exemplary diagram showing an FOV of a gesture recognition device to which an optical device is coupled.

Referring to FIGS. 9 and 10, it may be seen that by coupling the first optical device 10a and the second optical device 10b to the conventional gesture recognition device 20, the FOV of the gesture recognition device 20 is expanded from θFOV to ΦFOV. Therefore, in the space expansion system according to an embodiment of the present disclosure, the space in which a hand gesture of a user may be recognized is expanded by 2θ1 in the x-axis direction and the z-axis direction.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

1. A meta-grating structure layer comprising:
a substrate; and
a plurality of nanostructures provided on the substrate,
wherein the nanostructures of different sizes are periodically arranged on the substrate.

2. The meta-grating structure layer of claim 1, wherein a shape of the plurality of nanostructures is a square pillar shape.

3. The meta-grating structure layer of claim 2, wherein a height of the plurality of nanostructures is determined based on a light efficiency of a first-order diffracted light according to the height of the nanostructures,
wherein the light efficiency is a ratio of an intensity of an light incident on the meta-grating layer and an intensity of the first-order diffracted light.

4. The meta-grating structure layer of claim 2, wherein a height of the plurality of nanostructures is between 600 nm and 1000 nm.

5. The meta-grating structure layer of claim 2, wherein a fill factor of the plurality of nanostructures increases periodically,
wherein the fill factor is a ratio of a width of a nanostructure and a width of a basis.

6. The meta-grating structure layer of claim 2, wherein a width of the plurality of nanostructures increases periodically,
wherein the width of the plurality of the nanostructures is between 30 nm to 380 nm.

7. The meta-grating structure layer of claim 1, wherein the plurality of nanostructures comprise TiO2.

8. The meta-grating structure layer of claim 1, wherein the substrate comprises fused silica.

9. A system for expanding a field of view ΦFOV) of a gesture recognition device, the system comprising:
one or more meta-grating structure layers according to claim 1; and
a gesture recognition device comprising one or more recognition sensors for recognizing a gesture of a user,
wherein each of the meta-grating structure layers is disposed on top of each of the recognition sensors to receive light output from each of the recognition sensors.
